(19) United States
(12) Patent Application Publication
(10) Pub. No.: US 2014/0346794 A1
(43) Pub. Date: Nov. 27, 2014

(54) Hand Held Firewood Handling Device

(71) Applicants: Michael William Kronenwetter, Valencia, PA (US); William Theodore Kronenwetter, California, MD (US); David Allen Kronenwetter, Leonardtown, MD (US)

(72) Inventors: Michael William Kronenwetter, Valencia, PA (US); William Theodore Kronenwetter, California, MD (US); David Allen Kronenwetter, Leonardtown, MD (US)

(21) Appl. No.: 14/285,868

(22) Filed: May 23, 2014

Related U.S. Application Data
(60) Provisional application No. 61/827,022, filed on May 24, 2013.

(51) Int. Cl. B25J 1/04

(52) U.S. Cl. CPC B25J 1/04
USPC 294/103.1; 294/209

(57) ABSTRACT

A hand-held firewood handling device (100) for grasping, lifting, and placing pieces of wood in and around a bonfire. The device is made of a rod (20) inserted into a tube (10), the rod formed with a handle (28) at one end and with a rotating prong (26) on the other end. The tube features a pair of spaced-apart stationary prongs (12) welded to its distal end, the stationary prongs positioned on the tube so that when the rod is rotated inside the tube, the rotating prong (26) is offset in the space between the stationary prongs (12). In use, the handle is rotated to move the rotating prong away from the stationary prongs and positioned over a log. Rotating the handle in an opposite direction until the prongs are securely around the log, the log is repositioned as desired and released by rotating the handle to open the prongs.

### CROSS REFERENCE To RELATED APPLICATION

Reference is made to and priority claimed from U.S. provisional application Ser. No. 6161/827,022, filed May 24, 2013.

### TECHNICAL FIELD

The present invention pertains to the field of hand held tools for lifting or moving objects. More particularly, the present invention pertains to hand held devices used to lift, transport, and arrange logs for use in a firepit or bonfire.

### BACKGROUND OF THE INVENTION

Many firewood handling devices exist. Common designs include a scissor action, and singular or double stationary prong designs. All of these common designs are awkward and difficult to use when lifting and arranging large or heavy logs in a burning fire. The common scissor action design in particular is useful for picking up small pieces of wood, but requires significant strength to lift and carry larger logs.

What is needed is an improved firewood handling device that can securely and ergonomically grasp, lift, and arrange logs of varying sizes and weights, and yet not require significant arm strength.

### DISCLOSURE OF INVENTION

The firewood handling device according to the invention is provided as a metal tube having at its distal end at least two fixed metal prongs in spaced apart relationship each prong bent approximately 90 degrees, and a metal rod having a handle at one end and a single prong bent at approximately 90 degrees at the opposite end, the rod rotatably inserted into the metal tube. The prongs of the rod and the tube are oriented such that when the rod is rotated inside the tube in a grasping direction, the bent tips of the single prong of the rod rotate towards the bent tips of the stationary tube prongs, allowing a user to adjustably grasp a piece of wood between the sets of prongs. When the rod is rotated in an opposite direction, the single prong rotates away from the stationary tube prongs, releasing the wood held by the prongs.

In another embodiment, the tube is fitted with a hand grasp near a proximal end of the tube to allow a user to grasp the handle with one hand, and steady the tube by holding the hand grasp with the other hand, allowing the user to safely and easily lift heavy or large pieces of wood securely and ergonomically, with a simple twist of the handle.

### BRIEF DESCRIPTION OF THE DRAWINGS

The features and advantages of the invention will become apparent from a consideration of the subsequent detailed description presented in connection with accompanying drawings, in which:

FIG. 1 is a side elevational view of the firewood handling device according to the invention.

FIGS. 2a-e are perspective views of the stationary-rotatable prongs shown as the inner rod is rotated inside the tube, moving the single prong towards the stationary prongs.

FIG. 3 is a perspective view of the firewood handling device being held by a user, shown with the prongs in grasping orientation, cause by the user holding the handle with one hand and rotating the inner rod while holding the tube with the other hand about the hand grasp.

FIGS. 4a-b are perspective views of the firewood handling device being used by a user actively moving burning logs in an outside campfire.

### DRAWINGS LIST OF REFERENCE NUMERALS

The following is a list of reference labels used in the drawings to label components of different embodiments of the invention, and the names of the indicated components.

100 firewood handling device

10 tube

12 stationary prong or leg of U-shaped trough

14 proximal end

16 distal end

18 weld

20 rod

22 handle end of rod

24 prong end of rod

26 rotating prong

28 handle

30 hand grasp

32 trough

34 tube length

40 log or firewood or other object lifted

50 grasping, or closed position

52 open position

### DETAILED DESCRIPTION

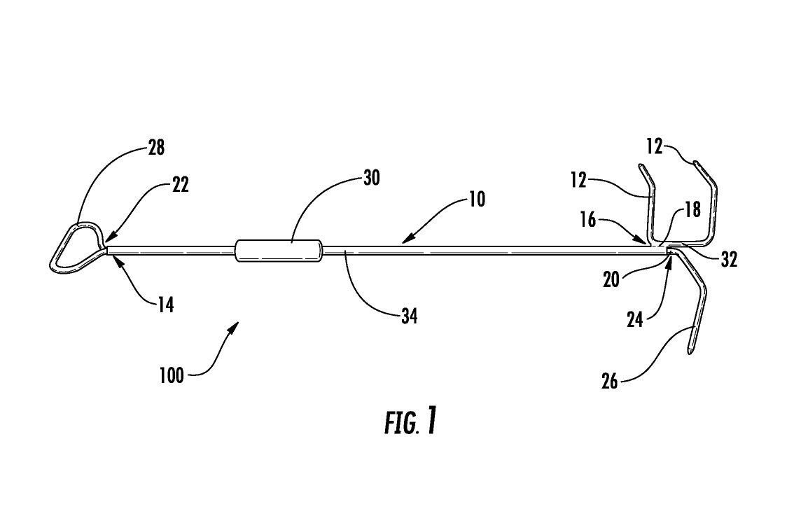

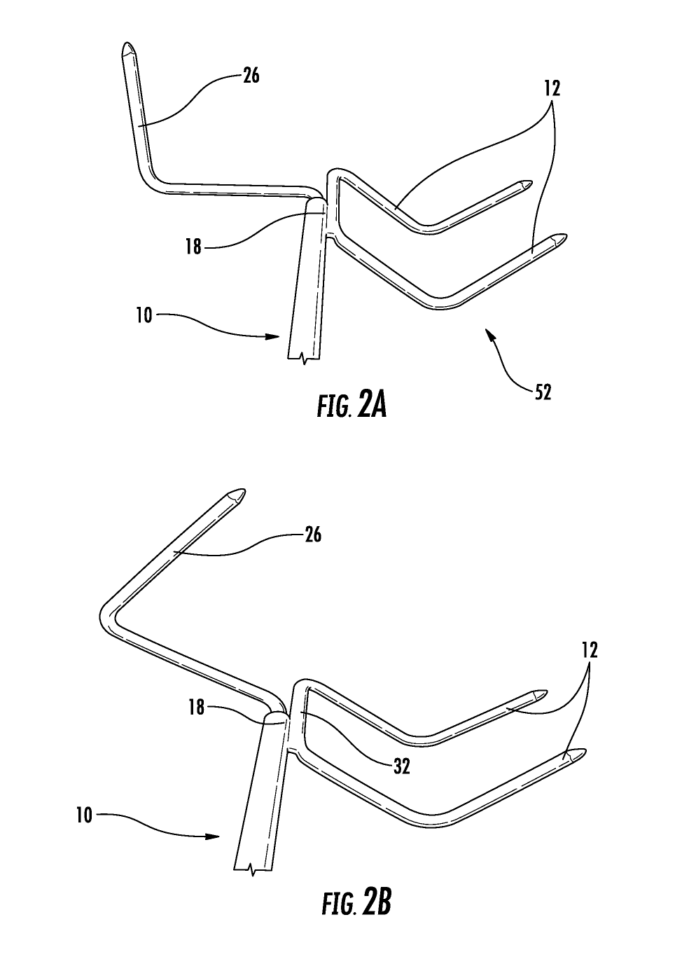

The firewood handling device according to the invention 100 is described in FIGS. 1-4b. Turning now to FIG. 1, the firewood handling device according to the invention 100 is comprised of a length 34 of tube 10, with a pair of spaced apart stationary prongs 12 affixed at a distal end 16 of the tube 10 by a weld 18, and in the embodiment shown, including a hand grasp 30 at a proximal end 14 of the tube 10. A rod 20 inserted into the tube 10 is rotatable inside the tube 10. The rod 20 is further comprised of a handle 28, formed by shaping the handle end 22 of the rod 20 into a loop, preferably a triangular loop. In other embodiments (not shown) the handle may be formed in any other shape suitable for grasping by a hand, such as a rectangle, a circle, T or C-shaped handles, etc. A prong end 24 of the rod 20 is comprised of a single rotating prong 26, fashioned by bending the prong end 24 of the rod 20 about 90 degrees and adding a second 90 degree bend in the prong, creating an L-shaped prong.

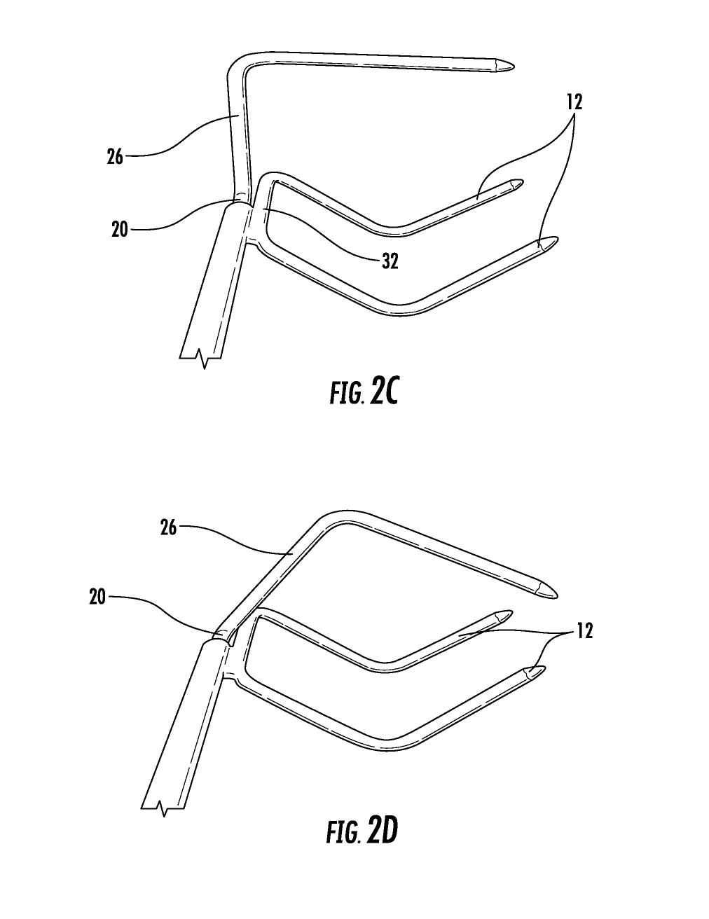

Looking now at FIGS. 2a-e, the degree of rotation travel of the rotating prong 26 is about 350 degrees. The prongs 12 26 are oriented so that when the rod 20 is rotated inside the tube 10 in a grasping or closed position 50, the stationary prongs 12 and the rotating prong 26 move towards one another, with the rotating prong 26 positioned between the stationary prongs 12 when the rod 20 travels its entire rotatable distance as shown in FIG. 2e into a fully closed position 50. In some embodiments, the rotating prong is centered between the stationary prongs, and in other embodiments, the rotating prong is offset. When the rod 20 is rotated in the opposite direction, the stationary prongs 12 and the rotating prong 12 move away from one another into an open position 52 as shown in FIGS. 2a-d.

When the rotating prong 26 is rotated in a grasping direction 50, the rotating prong 26 rotates to grasp firewood 40, burning or not, against the stationary prongs 12 mounted permanently to the tube 10. In a preferred embodiment, the pair of stationary prongs 12 are formed with two 90 degree bends, although in other embodiments, it is possible that the second bend can range from about 45-90 degrees. The inventors feel the unique feature of their firewood handling device 100 is the rotating prong 26 which closes between the pair of stationary prongs 12 enabling the gripping, lifting, and placing action of the device 100. A hand grasp 30, preferably a wooden dowel fitted to the tube approximately ⅓ the distance of the entire tube near the proximal end 14 of the tube is also provided in one embodiment of the invention. The hand grasp 30 increases the torque applied for ease of gripping the firewood 40 while a first hand holding the handle 28 applies torque via the handle 28.

The firewood handling device 100 is preferably constructed using steel, aluminum, or another suitable strong heat resistant metal or other heat resistant material. In one embodiment, the tube 10 is comprised of a 3 foot length of ½ inch steel with a 1/16 inch wall steel tubing, the rod 20 is comprised of a 6 foot length of hot rolled steel 5/16 inch in diameter, and the hand grasp 30 is comprised of a 4.5 inch length of a hard wooden dowel 1.25 inches in diameter with a 0.5 inch hole running directly through the center length of the dowel. The wooden dowel is positioned via a pressure fit and glue on the steel tubing approximately 12 inches from the proximal end of the steel tubing. The hand grasp 30 ideally is made of wood so as to provide a lightweight, insulated grasp that will protect the user's hand from heat absorbed by the device 100, however other heat-resistant materials can also be used, including using heat resistant coatings.

In a typical method of constructing the firewood handling device 100, to form the pair of stationary prongs 12, a 15 inch segment is cut from an end of the 6 foot rod and shaped into a pair of stationary prongs 12 by first bending the 15 inch segment into a U-shape piece, each leg of the U-shape piece being about 6 inches in length and the trough 32 of the U-shape piece being about 3 inches in length. Each leg 12 of the U-shaped piece is then bent about 90 degrees perpendicular to the plane of the U-shape piece, forming 2 parallel L-shaped pieces about 3 inches in length. The double-pronged U-shaped piece is affixed to the distal end 16 of the tube 10 by a weld 18, creating the pair of stationary prongs 12 of the device 100.

The remaining section of the 5/16 inch rod is formed into a triangular handle at its handle end 22 by bending the rod 20 approximately 14.5 inches from the handle end 22 approximately 45 degrees then bending a 1 inch round 90 degree bend in the same plane approximately 8 inches from the same end and then another 1 inch round 90 degree bend approximately 4 inches from the same end completing a triangle in a single plane. The inventors note that the triangular shape is a preferred embodiment, however the handle 28 could also be bent into a variety of suitable shapes.

After the handle 28 has been formed, the prong end 24 of the rod (but before the rotating prong 26 is shaped) is inserted into the steel tube 10, and the protruding prong end 24 of the rod 20 is bent to form the rotating prong 26, at approximately a position along a length of the rod at which the rod exits the tube 10. The prong end 24 is first bent approximately 90 degrees, and then about 3 inches from its free end, bent again another approximately 90 degrees, creating an L-shaped prong 26 perpendicular to the plane of the previous bend and to the handle 28. The inventors note that the second bend in the prong 26 is typically 90 degrees, however in some embodiments this bend can range from about 45 to 90 degrees.

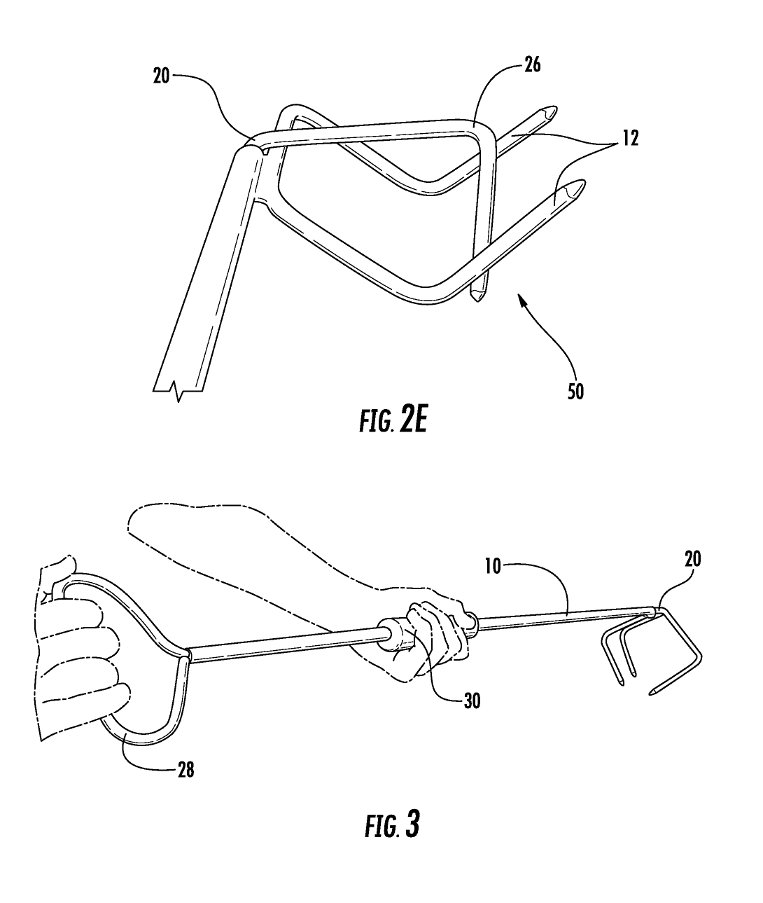

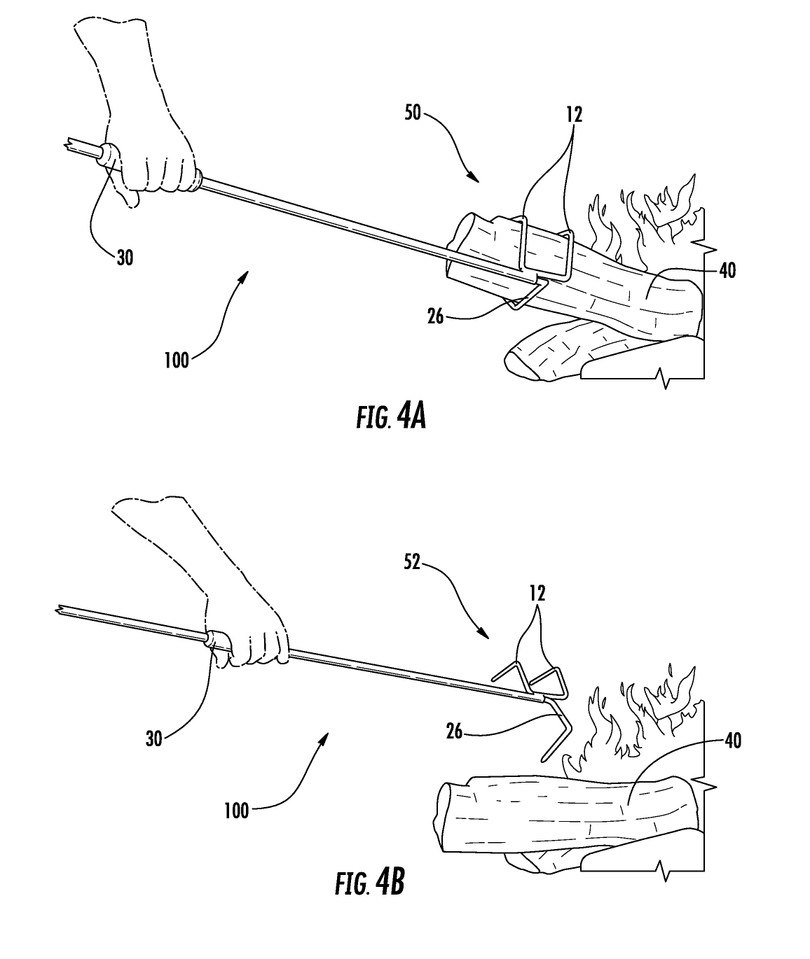

Looking now at FIGS. 3, and 4a-b, a user grasps the firewood handling device 100 by the handle 28 with the first hand and the hand grasp 30 with an opposite hand. To pick up the firewood 40, the user rotates the handle 28 in an open direction 52 to move the rotating prong 26 away from the pair of stationary prongs 12 to position the prongs 12 26 in the grasping position 50. The user then positions the prongs 12 26 around typically a narrowest circumference of the firewood 40, and rotates the handle 28 in the grasping direction 50, to close the prongs 12 26 together to grasp the firewood 40 firmly. The user can then easily carry the firewood to a desired location and release it accurately and carefully by simply rotating the handle 28 and moving the prongs 12 26 apart.

It is to be understood that the above-described arrangements are only illustrative of the application of the principles of the present invention. Numerous modifications and alternative arrangements may be devised by those skilled in the art without departing from the scope of the present invention. For instance, the lengths provided for the rod and tube can be varied so as to create relatively long or short firewood handling devices, depending on the size of the campfire and also depending on the size of the logs to be moved. Relatively shorter devices 100 just 3 feet long, for instance, can be created for residential fireplaces, while a device 6 feet or longer might be more suitable for campfire or bonfire use. The length and angling of the prongs are also variable, and relatively longer prongs than described above could be used to accommodate firewood with larger diameters or irregular shapes. The inventors also note that three prongs are the minimal number of prongs needed for the invention, however, additional prongs could be included, either as more stationary prongs 12 affixed to the tube 10, or as additional rotating prongs 26 formed at the prong end 24 of the rod 20. Such additional prongs would facilitate the handling of very long or bulky items. The inventors also note that the inspiration for their invention was solving the problem of handling large pieces of burning firewood, the device 100 could also easily be modified to grab a number of different things, not just firewood, and modifications to the number and length of prongs, for instance, can be envisioned. Also, the method of constructing the device 100 as described is just one possible method, and other methods may be used, along with a variety of heat resistant materials. The invention is of particular use to help grab objects when the user's hand strength is limited or compromised.

What is claimed is:

1. A firewood handling device (100), comprising:
a rod (20) having a handle end (22) and a prong end (24) defining a rod length;
a handle (28) formed at the handle end of the rod (22), and a rotatable prong(26) formed at the prong end of the rod (24);
a tube (10) having a proximal end (14) and a distal end (16) defining a tube length (34); and
at least a pair of stationary prongs (2) in spaced apart relation affixed to the distal end (16) of the tube(10);
wherein the rod (20)is rotatably positioned inside the tube length (34),
wherein the rotatable prong (26) and the pair of stationary prongs (12) are each formed with at least one 90 degree bend, and
wherein the rotatable prong (26) is located between the pair of stationary prongs (12), and
wherein an open position (52) of the handling device (100) is achieved by rotating the rod (20) in a first direction, and a closed position (50) of the handling device (100) is achieved by rotating the rod (20) in an opposite direction.

2. The firewood handling device (100) of claim 1, wherein the open position further comprises a rotational degree of travel of the rotating prong (26) of up to 350 degrees.

3. The pair of stationary prongs in claim 1, further comprising a U-shaped piece having a pair of upright arm portions (12) held in spaced apart relationship by a trough portion, the U-shaped piece affixed to the distal end of the tube with the trough portion (32) oriented in parallel with the tube length (34), and a 90 degree bend perpendicular to the tube length forming a pair of upright arm portions (12).

4. The firewood handling device (100) of claim 1, wherein the device is made of a heat resistant material.

5. The firewood handling device (100) of claim 4, wherein the heat resistant material is steel.

6. The firewood handling device (100) of claim 1, further comprising a hand grasp (30) affixed to the tube (10).

7. The hand grasp (30) of claim 6, wherein the hand grasp is made of a heat resistant and heat shielding material.

8. The hand grasp (30) of claim 7, wherein the hand grasp is made of wood.

9. A method of moving and carrying firewood using a firewood handling device, comprising the steps of:
grasping the handle of the firewood handling device with one hand;
grasping the hand grasp of the firewood handling device with the other hand;
rotating the handle in a first direction to move the rotating prong into an open position (52);
positioning the prongs in the open position over a selected object (40);
rotating the handle in an opposite direction to move the rotating prong (26) towards the pair of stationary prongs (12) and around the selected object for the entire possible rotational distance;
moving the selected object to a desired location; and
rotating the handle in the first direction to position the rotating prong in the open position (2) to release the selected object.

10. The method of claim 9, wherein the selected object is a piece of wood.

11. A method of forming a firewood handling device (100), the method comprising the steps of:
inserting a malleable rod (20) into a tube (10);
bending one end of the malleable rod into a handle (28);
bending an opposing end of the malleable rod (10) 90 degrees so as to be perpendicular with the length of the malleable rod and creating a rotating prong (26);
forming a second 90 degree bend parallel to and in spaced apart relation with the first 90 degree bend;
forming a U-shaped piece with a 90 degree bend in the arms of the U-shaped piece; and
welding the U-shaped piece to the tube (10) opposite the handle end (22), with the trough (32) of the U shaped piece parallel to the length (34)of the tube, and the bent arms (12) of the U-shaped piece perpendicular to the length of the tube, with the rotating prong (26) located between the bent prongs of the U-shaped piece, with the bent prongs of the rotating prong (26) forming an L-shape and the bent prongs of the U-shaped piece forming a reverse L-shape,
whereby rotating the rod in a closed position (50) causes the rotating prong to move towards and between the stationary prongs (12), and
whereby rotating the rod into an open position (52) causes the rotating prong (26) to move away from the stationary prongs (12).

12. The method of claim 11, further comprising the step of pressuring-fitting a hand grasp (30) onto the tube (10) about one third of the length of the tube near the handle end of the tube.
